(19) United States
(12) Patent Application Publication
(10) Pub. No.: US 2007/0205395 A1
(43) Pub. Date: Sep. 6, 2007

(54) Liquid crystalline polyrotaxane

(75) Inventors: Takao Nakajima, Tokyo (JP); Masatoshi Kidowaki, Tokyo (JP); Jun Araki, Saitama (JP); Toshiyuki Kataoka, Tokyo (JP); Kohzo Ito, Tokyo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: The University of Tokyo, Tokyo (JP)

(21) Appl. No.: 11/515,177

(22) Filed: Sep. 1, 2006

(30) Foreign Application Priority Data
Mar. 3, 2006 (JP) JP2006-058166

(51) Int. Cl. C09K 19/52

(52) U.S. Cl. 252/299.01

(57) ABSTRACT

The present invention provides a liquid crystalline material having flexibility and/or bendability and a method for preparing the material. The present invention provides a liquid crystalline polyrotaxane consisting essentially of a polyrotaxane, wherein the polyrotaxane comprises a linear molecule, a cyclic molecule(s) in which the linear molecule is included in cavity (cavities) of the cyclic molecule(s) in a skewered manner, and capping groups, each of which locates at each end of the linear molecule in order to prevent the dissociation of the cyclic molecule (s); the cyclic molecule of the liquid crystalline polyrotaxane comprises a mesogenic group, e.g., biphenyl groups represented by following formulae (1) to (3), and the liquid crystalline polyrotaxane has liquid crystalline property.

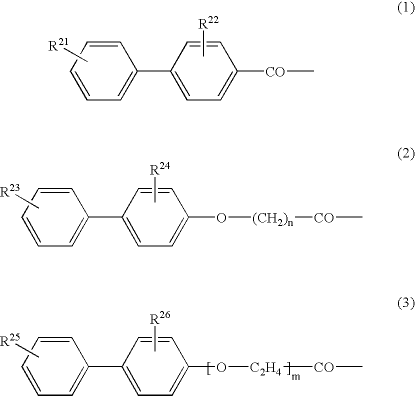

### BACKGROUND OF THE INVENTION

1. Field of the Invention

The present invention relates to a liquid crystalline polyrotaxane and a method for preparing the liquid crystalline polyrotaxane.

2. Description of Related Art

In recent appliances, particularly in displays, a large number of various liquid crystals are used. Portable devices such as a laptop computer, PDA and a cell phone are required to be further reduced in size and weight, and a wearable computer, which is one form of portable devices, is requested to be developed. Accordingly, displays, for example, for a wearable computer are required to have flexibility/bendability.

On the other hand, U.S. Pat. No. 6,828,378B2 discloses a crosslinked polyrotaxane, which is formed by crosslinking polyrotaxanes, which is comprised of pseudopolyrotaxane, which comprises a linear molecule (axis) and cyclic molecules (rota) in which the linear molecule is included in cavities of cyclic molecules in a skewered manner, and capping groups, each of which locates at each end of the pseudopolyrotaxane (each end of the linear molecule) in order to prevent the dissociation of the cyclic molecules. The crosslinked polyrotaxane has viscoelasticity generated by the movement of cyclic molecules. Accordingly, even if tension is applied to the crosslinked polyrotaxane, the action of the cyclic molecules can allow the tension to be dispersed uniformly throughout the crosslinked polyrotaxane.

### BRIEF SUMMARY OF THE INVENTION

An object of the present invention is to meet the needs described above.

Specifically, an object of the present invention is to provide a liquid crystalline material having flexibility and/or bendability and a method for preparing the material.

As the result of extensive investigation to achieve the object, the present inventors have found that a polyrotaxane comprising cyclic molecules having a mesogenic group exhibits liquid crystallinity. Specifically, the present inventors have found the following inventions:

<1> A liquid crystalline polyrotaxane consisting essentially of a polyrotaxane,

wherein the polyrotaxane comprises a linear molecule, a cyclic molecule(s) in which the linear molecule is included in cavity (cavities) of the cyclic molecule(s) in a skewered manner, and capping groups, each of which locates at each end of the linear molecule in order to prevent the dissociation of the cyclic molecule(s);

the cyclic molecule of the liquid crystalline polyrotaxane comprises a mesogenic group, and

the liquid crystalline polyrotaxane has liquid crystalline property.

<2> In the above item <1>, the mesogenic group may be represented by the formula A-X—B—C—Y— wherein A and B are 6-membered rings; C is a single bond or a liner chain group; and X and Y are bonding groups.

<3> In the above item <2>, the 6-membered rings of A and B each independently represents a saturated or unsaturated homo- or heterocycle, which may be substituted. Preferably, A may be a p-cyanophenyl group, and B may be benzene ring without substituents.

<4> In the above item <2> or <3>, C may have a linear chain consisting of 0 to 100 elements, preferably to 70 elements, more preferably 0 to 30 elements. C may comprise —O— or a benzene ring in the linear chain. In a case where C comprises a benzene ring in the linear chain, “the number of elements constructing the linear chain” of the benzene ring is considered to be 4 for convenience, in the present application. C may be preferably a linear alkyl chain or linear alkyl ether chain.

<5> In any one of the above items <2> to <4>, X may be selected from the group consisting of a single bond, —CO—O—, —O—CO—, —N═N—, an azoxy group, —N═CH—, —CH═N—, —CH═CH— and —C≡C—. Preferably, X may be selected from the group consisting of a single bond, —CO—O—, —O—CO—, —N═N—, an azoxy group, —N═CH—, —CH═N— and —CH═CH—. More preferably, X may be a single bond, —CO—O— or —O—CO—.

<6> In any one of the above items <2> to <5>, Y may be selected from the group consisting of a single bond, —O—, —CO—, —CO—O—, —O—CO—, —NH—CO—, —CO—NH—, —NH—CO—O— and —O—CO—NH—. Preferably, Y may be selected from the group consisting of —CO—O—, —O—, —NH—CO—O— and —O—CO—. More preferably, Y may be —CO—O—.

<7> In any one of the above items <2> to <6>, A-X—B— may be selected from the group consisting of D-1 to D-20 wherein R¹ to R²⁰ each independently represents a substituent:

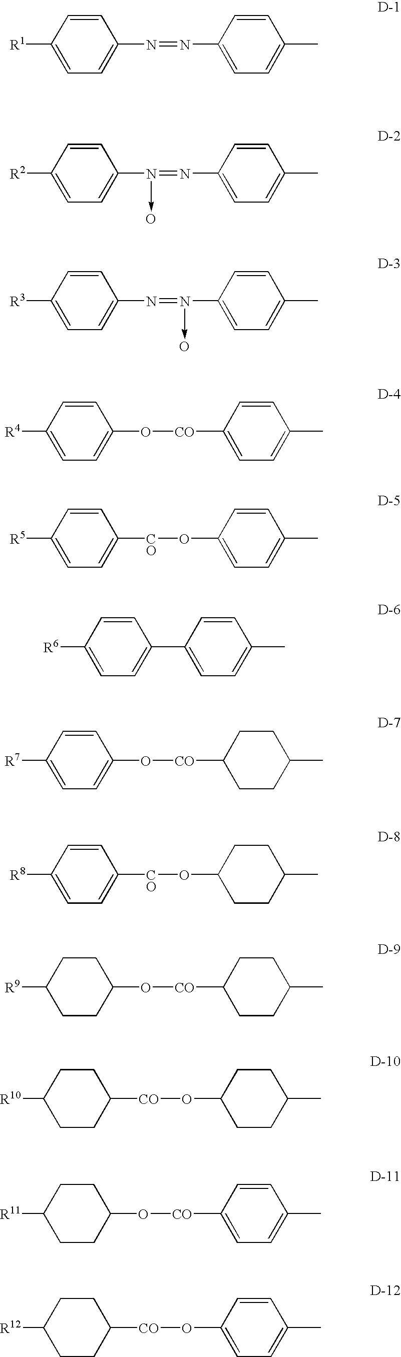

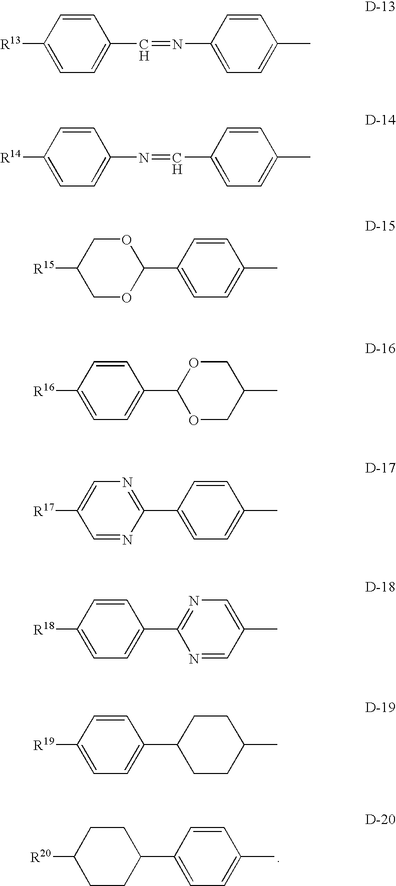

R¹ to R²⁰ each may independently represent a cyano group, F, Cl, an alkyl group (preferably a linear alkyl group) having 1 to 20 carbons, preferably 1 to 15 carbons, an alkoxy group (preferably a linear alkoxy group) having 1 to 20 carbons, preferably 1 to 15 carbons, an alkylcarbonyloxy or alkyloxycarbonyl group (preferably a linear alkylcarbonyloxy or alkyloxycarbonyl group) having 1 to 20 carbons, preferably 1 to 15 carbons, a fluorocarbon (preferably a linear fluorocarbon) having 1 to 20 carbons, preferably 1 to 15 carbons, or a nitro group. In particular, A-X—B— may be D-1 to D-14, D-19 or D-20, preferably D-2 to D-14, D-19 or D-20, more preferably D-4 to D-14, D-19 or D-20, and especially D-6.

<8> In any one of the above items <1> to <7>, the mesogenic group may represent any one of biphenyl substituents represented by following formulae 1 to 3, wherein n is an integer of 1 to 20; m is an integer of 1 to 10; R²¹, R²³ and R²⁵ each independently represents 0 to 5 substituents; and R²², R²⁴ and R²⁶ each independently represents 0 to 4 substituents:

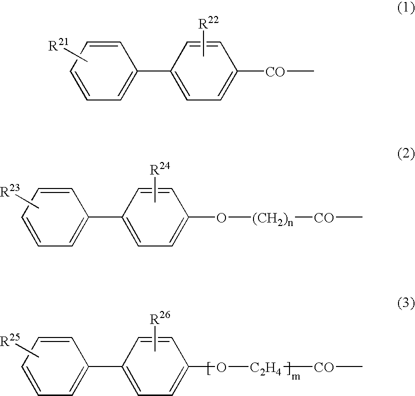

<9> In the above item <8>, the biphenyl substituent may be represented by the formula 1, wherein R²¹ may have one substituent which is a cyano group in p-position, and R²² may have no substituent.

<10> In the above item <8>, the biphenyl substituent may be represented by the formula 2, wherein n may be an integer of 2 to 10, preferably 3 to 8, in particular 5, R²³ may have one substituent which is a cyano group in p-position, and R²⁴ may have no substituent.

<11> In the above item <8>, the biphenyl substituent may be represented by the formula 3, wherein m may be an integer of 1 to 5, preferably 2 to 4, in particular 2, R²⁵ may have one substituent which is a cyano group in p-position, and R²⁶ may have no substituent.

<12> In any one of the above items <1> to <11>, the linear molecule may be selected from the group consisting of polyvinyl alcohol, polyvinylpyrrolidone, poly(meth)acrylic acid, cellulose-based resins (carboxymethylcellulose, hydroxyethylcellulose, hydroxypropylcellulose and the like), polyacrylamide, polyethylene oxide, polyethylene glycol, polypropylene glycol, polyvinyl acetal-based resins, polyvinyl methyl ether, polyamine, polyethyleneimine, casein, gelatin, starch and the like and/or copolymers thereof, polyolefin-based resins such as polyethylene, polypropylene, and copolymer resins with other olefinic monomers, polyester resins, polyvinyl chloride resins, polystyrene-based resins such as polystyrene, acrylonitrile-styrene copolymer resin and the like, acrylic resins such as polymethyl methacrylate, (meth)acrylate copolymer, acrylonitrile-methyl acrylate copolymer resin and the like, polycarbonate resins, polyurethane resins, vinyl chloride-vinyl acetate copolymer resin, polyvinylbutyral resin and the like; and derivatives and modifications thereof, polyisobutylene, polytetrahydrofuran, polyaniline, acrylonitrile-butadiene-styrene copolymer (ABS resin), polyamides such as nylon and the like, polyimides, polydienes such as polyisoprene, polybutadiene and the like, polysiloxanes such as polydimethylsiloxane and the like, polysulfones, polyimines, polyacetic anhydrides, polyureas, polysulfides, polyphosphazenes, polyketones, polyphenylenes, polyhaloolefins, and derivatives thereof. For example, the linear molecule may be selected from the group consisting of polypropylene glycol, polytetrahydrofuran, polydimethylsiloxane, polyethylene and polypropylene, and preferably polyethylene glycol.

<13> In any one of the above items <1> to <12>, the linear molecule may have a molecular weight of 500 or more, preferably 1,000 or more, more preferably 2,000 or more.

<14> In any one of the above items <1> to <13>, the capping group may be selected from the group consisting of dinitrophenyl groups; cyclodextrins; adamantane groups; trityl groups; fluoresceins; pyrenes; substituted benzenes (example of the substituent may include, but are not limited to, alkyl, alkyloxy, hydroxy, halogen, cyano, sulfonyl, carboxyl, amino, phenyl and the like. The substituent may be single or plural.); polycyclic aromatics which may be substituted (examples of the substituent may include, but are not limited to, those described above. The substituent may be single or plural.); and steroids. Preferably, the capping group may be selected from the group consisting of dinitrophenyl groups; cyclodextrins; adamantane groups; trityl groups; fluoresceins; and pyrenes, more preferably adamantane groups; or trityl groups.

<15> In any one of the above items <1> to <14>, the cyclic molecule may be a cyclodextrin molecule which may be substituted.

<16> In any one of the above items <1> to <15>, the cyclic molecule may be a cyclodextrin molecule which may be substituted, and the cyclodextrin molecule may be selected from the group consisting of α-cyclodextrin, β-cyclodextrin and γ-cyclodextrin, and derivatives thereof.

<17> In any one of the above items <1> to <16>, the cyclic molecule may be α-cyclodextrin which may be substituted, and the linear molecule may be polyethylene glycol.

<18> In any one of the above items <1> to <17>, the linear molecule may have the cyclic molecule included in a skewered manner at an amount of 0.01 to 0.99, preferably 0.1 to 0.9, more preferably 0.2 to 0.8 of a maximum inclusion amount, which is defined as an amount at which the cyclodextrin molecule can be included at maximum when the linear molecule has the cyclic molecules included in a skewered manner, and the amount at maximum is normalized to be 1.

<19> In any one of the above items <1> to <18>, the liquid crystalline polyrotaxane may be used for at least one selected from the group consisting of materials for display, display elements, recording materials, lithium ion cells, fuel cells, solar cells, actuator, electric double layer capacitors, light-emitting devices, electrochromism elements, sensors, ionics circuits, polyelectrolyte, electrochemical materials, catalysts, separation membranes, and coating agents.

<20> A method for preparing a liquid crystalline polyrotaxane consisting essentially of a polyrotaxanes and exhibiting liquid crystallinity, comprising the steps of:

a) mixing a cyclic molecule(s) and a linear molecule to make the linear molecule being included in the cyclic molecule(s) in a skewered manner; and

b) capping each end of the linear molecule with a capping group to prevent the dissociation of the cyclic molecule from the linear molecule, to prepare the polyrotaxane; and further comprising:

c) introducing a mesogenic group into the cyclic molecule; in the any timing of the following i) to v);

i) before step a),

ii) during step a),

iii) after step a) and before step b),

iv) during step b), or

v) after step b).

<21> The step c) in the above item <20> may be conducted at the timing (v) after the step b).

<22> In the step c) in the above item <20> or <21>, the mesogenic group can be introduced by reacting acid chloride, that will become the mesogenic group, in the presence of triethylamine.

<23> In any one of the above items <20> to <22>, the mesogenic group may be represented by the formula A-X—B—C—Y— wherein A and B are 6-membered rings; C is a single bond or a liner chain group; and X and Y are bonding groups.

<24> In the above item <23>, the 6-membered rings of A and B each independently represents a saturated or unsaturated homo- or heterocycle, which may be substituted. Preferably, A may be a p-cyanophenyl group, and B may be benzene ring without substituents.

<25> In the above item <23> or <24>, C may have a linear chain consisting of 0 to 100 elements, preferably 0 to 70 elements, more preferably 0 to 30 elements. C may comprise —O— or a benzene ring in the linear chain. In a case where C comprises a benzene ring in the linear chain, “the number of elements constructing the linear chain” of the benzene ring is considered to be 4 for convenience, in the present application. C may be preferably a linear alkyl chain or linear alkyl ether chain.

<26> In any one of the above items <23> to <25>, X may be selected from the group consisting of a single bond, —CO—O—, —O—CO—, —N═N—, an azoxy group, —N═CH—, —CH═N—, —CH═CH— and —C≡C—. Preferably, X may be selected from the group consisting of a single bond, —CO—O—, —O—CO—, —N═N—, an azoxy group, —N═CH—, —CH═N— and —CH═CH—. More preferably, X may be a single bond, —CO—O— or —O—CO—.

<27> In any one of the above items <23> to <26>, Y may be selected from the group consisting of a single bond, —O—, —CO—, —CO—O—, —O—CO—, —NH—CO—, —CO—NH—, —NH—CO—O— and —O—CO—NH—. Preferably, Y may be selected from the group consisting of —CO—O—, —O—, —NH—CO—O— and —O—CO—. More preferably, Y may be —CO—O—.

<28> In any one of the above items <23> to <27>, A-X—B— may be selected from the group consisting of the above-described D-1 to D-20 wherein R¹ to R²⁰ each independently represents a substituent. R¹ to R²⁰ each may independently represent a cyano group, F, Cl, an alkyl group (preferably a linear alkyl group) having 1 to 20 carbons, preferably 1 to 15 carbons, an alkoxy group (preferably a linear alkoxy group) having 1 to 20 carbons, preferably 1 to 15 carbons, an alkylcarbonyloxy or alkyloxycarbonyl group (preferably a linear alkylcarbonyloxy or alkyloxycarbonyl group) having 1 to 20 carbons, preferably 1 to 15 carbons, a fluorocarbon (preferably a linear fluorocarbon) having 1 to 20 carbons, preferably 1 to 15 carbons, or a nitro group. In particular, A-X—B— may be D-1 to D-14, D-19 or D-20, preferably D-2 to D-14, D-19 or D-20, more preferably D-4 to D-14, D-19 or D-20, and especially D-6.

<29> In any one of the above items <20> to <28>, the mesogenic group may represent any one of biphenyl substituents represented by the above-described formulae 1 to 3, wherein n is an integer of 1 to 20; m is an integer of 1 to 10; R²¹, R²³ and R²⁵ each independently represents 0 to 5 substituents; and R²², R²⁴ and R²⁶ each independently represents 0 to 4 substituents.

<30> In the above item <29>, the biphenyl substituent may be represented by the formula 1, wherein R²¹ may have one substituent which is a cyano group in p-position, and R²² may have no substituent.

<31> In the above item <29>, the biphenyl substituent may be represented by the formula 2, wherein n may be an integer of 2 to 10, preferably 3 to 8, in particular 5, R²³ may have one substituent which is a cyano group in p-position, and R²⁴ may have no substituent.

<32> In the above item <29>, the biphenyl substituent may be represented by the formula 3, wherein m may be an integer of 1 to 5, preferably 2 to 4, in particular 2, R²⁵ may have one substituent which is a cyano group in p-position, and R²⁶ may have no substituent.

<33> In any one of the above items <30> to <32>, each of acid chloride derivatives of the group represented by the above-described formulae 1 to 3 is reacted with the polyrotaxane in the presence of triethylamine.

<34> In any one of the above items <20> to <33>, the linear molecule may be selected from the group consisting of polyvinyl alcohol, polyvinylpyrrolidone, poly(meth)acrylic acid, cellulose-based resins (carboxymethylcellulose, hydroxyethylcellulose, hydroxypropylcellulose and the like), polyacrylamide, polyethylene oxide, polyethylene glycol, polypropylene glycol, polyvinyl acetal-based resins, polyvinyl methyl ether, polyamine, polyethyleneimine, casein, gelatin, starch and the like and/or copolymers thereof, polyolefin-based resins such as polyethylene, polypropylene, and copolymer resins with other olefinic monomers, polyester resins, polyvinyl chloride resins, polystyrene-based resins such as polystyrene, acrylonitrile-styrene copolymer resin and the like, acrylic resins such as polymethyl methacrylate, (meth)acrylate copolymer, acrylonitrile-methyl acrylate copolymer resin and the like, polycarbonate resins, polyurethane resins, vinyl chloride-vinyl acetate copolymer resin, polyvinylbutyral resin and the like; and derivatives and modifications thereof, polyisobutylene, polytetrahydrofuran, polyaniline, acrylonitrile-butadiene-styrene copolymer (ABS resin), polyamides such as nylon and the like, polyimides, polydienes such as polyisoprene, polybutadiene and the like, polysiloxanes such as polydimethylsiloxane and the like, polysulfones, polyimines, polyacetic anhydrides, polyureas, polysulfides, polyphosphazenes, polyketones, polyphenylenes, polyhaloolefins, and derivatives thereof. For example, the linear molecule may be selected from the group consisting of polypropylene glycol, polytetrahydrofuran, polydimethylsiloxane, polyethylene and polypropylene, and preferably polyethylene glycol.

<35> In any one of the above items <20> to <34>, the linear molecule may have a molecular weight of 500 or more, preferably 1,000 or more, more preferably 2,000 or more.

<36> In any one of the above items <20> to <35>, the capping group may be selected from the group consisting of dinitrophenyl groups; cyclodextrins; adamantane groups; trityl groups; fluoresceins; pyrenes; substituted benzenes (example of the substituent may include, but are not limited to, alkyl, alkyloxy, hydroxy, halogen, cyano, sulfonyl, carboxyl, amino, phenyl and the like. The substituent may be single or plural.); polycyclic aromatics which may be substituted (examples of the substituent may include, but are not limited to, those described above. The substituent may be single or plural.); and steroids. Preferably, the capping group may be selected from the group consisting of dinitrophenyl groups; cyclodextrins; adamantane groups; trityl groups; fluoresceins; and pyrenes, more preferably adamantane groups; or trityl groups.

<37> In any one of the above items <20> to <36>, the cyclic molecule may be a cyclodextrin molecule which may be substituted.

<38> In any one of the above items <20> to <37>, the cyclic molecule may be a cyclodextrin molecule which may be substituted, and the cyclodextrin molecule may be selected from the group consisting of α-cyclodextrin, β-cyclodextrin and γ-cyclodextrin, and derivatives thereof.

<39> In any one of the above items <20> to <38>, the cyclic molecule may be α-cyclodextrin which may be substituted, and the linear molecule may be polyethylene glycol.

<40> In any one of the above items <20> to <39>, the linear molecule may have the cyclic molecule included in a skewered manner at an amount of 0.01 to 0.99, preferably 0.1 to 0.9, more preferably 0.2 to 0.8 of a maximum inclusion amount, which is defined as an amount at which the cyclodextrin molecule can be included at maximum when the linear molecule has the cyclic molecules included in a skewered manner, and the amount at maximum is normalized to be 1.

<41> In any one of the above items <20> to <40>, the liquid crystalline polyrotaxane may be used for at least one selected from the group consisting of materials for display, display elements, recording materials, lithium ion cells, fuel cells, solar cells, actuator, electric double layer capacitors, light-emitting devices, electrochromism elements, sensors, ionics circuits, polyelectrolyte, electrochemical materials, catalysts, separation membranes, and coating agents.

### BRIEF DESCRIPTION OF DRAWINGS

FIG. 1 is a graph showing DSC curves of CNBP—C₅-APR obtained in Example 1 for the third cycle of rising and decreasing temperature and DSC curves of unmodified polyrotaxane, which is a raw material, for the second cycle of rising and decreasing temperature on the inside, as a comparative control;

FIG. 2 shows a polarized light microscope image of CNBP—C₅-APR obtained in Example 1 in the cycle of rising and decreasing temperature;

FIG. 3 is a graph showing DSC curves of CNBP-(EO)₂-APR obtained in Example 2 for the second cycle of rising and decreasing temperature and DSC curves of unmodified polyrotaxane, which is a raw material, for the second cycle of rising and decreasing temperature on the inside similarly as in FIG. 1, as a control; and

FIG. 4 shows a polarized light microscope image of CNBP-(EO)₂-APR obtained in Example 2 in the cycle of rising and decreasing temperature.

### DETAILED DESCRIPTION OF THE INVENTION

The present invention will be described in detail hereinafter.

### <Liquid Crystalline Polyrotaxane>

The present invention provides a liquid crystalline polyrotaxane having liquid crystallinity consisting essentially of a polyrotaxane. The phrase “consisting essentially of” used herein means that the liquid crystalline polyrotaxane may contain an additive, solvent or the like other than the polyrotaxane, but does not contain a material exhibiting liquid crystallinity (e.g., a known liquid crystalline material) other than the polyrotaxane.

The polyrotaxane comprises a linear molecule, a cyclic molecule(s) in which the linear molecule is included in cavity (cavities) of the cyclic molecule(s) in a skewered manner, and capping groups, each of which locates at each end of the linear molecule in order to prevent the dissociation of the cyclic molecule(s).

The cyclic molecule in the liquid crystalline polyrotaxane has a mesogenic group.

A mesogenic group used herein refers a group exhibiting a mesophase formation by temperature change such as heating and cooling, or by an effect of a certain amount of solvent.

The mesogenic group may be a group represented by the formula A-X—B—C—Y—, wherein A and B are 6-membered rings, C is a single bond or a liner chain group, and X and Y are bonding groups.

6-membered rings of A and B may independently be saturated or unsaturated homo- or heterocycles, which may be substituted, and preferably benzene rings which may be substituted. More preferably, A may be a p-cyanophenyl group and B may be an unsubstituted benzene ring.

C may be a linear chain consisting of 0 to 100 elements, preferably 0 to 70 elements, and more preferably 0 to 30 elements. C may comprise —O— or a benzene ring in the linear chain. If C comprises a benzene ring in the linear chain, “the number of elements constructing the linear chain” of the benzene ring is considered to be 4 for convenience, in the present application. C may be preferably a linear alkyl chain or linear alkyl ether chain.

X may be selected from the group consisting of a single bond, —CO—O—, —O—CO—, —N═N—, an azoxy group, —N═CH—, —CH═N—, —CH═CH— and —C≡C—. Preferably, X may be selected from the group consisting of a single bond, —CO—O—, —O—CO—, —N═N—, azoxy group, —N═CH—, —CH═N— and —CH═CH—. More preferably, X may be a single bond, —CO—O— or —O—CO—.

Y may be selected from the group consisting of a single bond, —O—, —CO—, —CO—O—, —O—CO—, —NH—CO—, —CO—NH—, —NH—CO—O— and —O—CO—NH—. Preferably, Y may be selected from the group consisting of —CO—O—, —O—, —NH—CO—O— and —O—CO—. More preferably, Y may be —CO—O—.

A-X—B— may be selected from the group consisting of above-described D-1 to D-20, wherein R¹ to R²⁰ have the same definition as defined above. R¹ to R²⁰ each may independently represent a cyano group, F, Cl, an alkyl group (preferably a linear alkyl group) having 1 to 20 carbons, preferably 1 to 15 carbons, an alkoxy group (preferably a linear alkoxy group) having 1 to 20 carbons, preferably 1 to 15 carbons, an alkylcarbonyloxy or alkyloxycarbonyl group (preferably a linear alkylcarbonyloxy or alkyloxycarbonyl group) having 1 to 20 carbons, preferably 1 to 15 carbons, a fluorocarbon (preferably a linear fluorocarbon) having 1 to 20 carbons, preferably 1 to 15 carbons, or a nitro group. In particular, A-X—B— may be D-1 to D-14, D-19 or D-20, preferably D-2 to D-14, D-19 or D-20, more preferably D-4 to D-14, D-19 or D-20, and especially D-6.

The mesogenic group may be any one of biphenyl substituents represented by the above-described formulae 1 to 3, wherein n, m, and R²¹ to R²⁶ have the same definition as defined above.

The biphenyl substituent may be represented by the formula 1, wherein the number of R²¹ is 1 which is a cyano group in p-position, and the number of R²² is 0.

Further, the biphenyl substituent may be represented by the formula 2, wherein n is an integer of 2 to 10, preferably an integer of 3 to 8, and especially 5, the number of R²³ is 1 which is a cyano group in p-position, and the number of R²⁴ is 0.

Moreover, the biphenyl substituent may be represented by the formula 3, wherein m is an integer of 1 to 5, preferably an integer of 2 to 4, and especially 2, the number of R²⁵ is 1 which is a cyano group in p-position, and the number of R²⁶ is 0.

The linear molecule of the liquid crystalline polyrotaxane according to the present invention may include polyvinyl alcohol, polyvinylpyrrolidone, poly(meth)acrylic acid, cellulose-based resins (carboxymethylcellulose, hydroxyethylcellulose, hydroxypropylcellulose and the like) polyacrylamide, polyethylene oxide, polyethylene glycol, polypropylene glycol, polyvinyl acetal-based resins, polyvinyl methyl ether, polyamine, polyethyleneimine, casein, gelatin, starch and the like and/or copolymers thereof, polyolefin-based resins such as polyethylene, polypropylene, and copolymer resins with other olefinic monomers, polyester resins, polyvinyl chloride resins, polystyrene-based resins such as polystyrene, acrylonitrile-styrene copolymer resin and the like, acrylic resins such as polymethyl methacrylate, (meth)acrylate copolymer, acrylonitrile-methyl acrylate copolymer resin and the like, polycarbonate resins, polyurethane resins, vinyl chloride-vinyl acetate copolymer resin, polyvinylbutyral resin and the like; and derivatives and modified bodies thereof, polyisobutylene, polytetrahydrofuran, polyaniline, acrylonitrile-butadiene-styrene copolymer (ABS resin), polyamides such as nylon and the like, polyimides, polydienes such as polyisoprene, polybutadiene and the like, polysiloxanes such as polydimethylsiloxane and the like, polysulfones, polyimines, polyacetic anhydrides, polyureas, polysulfides, polyphosphazenes, polyketones, polyphenylenes, polyhaloolefins, and derivatives thereof. The linear molecule may be selected from the group consisting of polyethylene glycol, polyisoprene, polyisobutylene, polybutadiene, polypropylene glycol, polytetrahydrofuran, polydimethylsiloxane, polyethylene and polypropylene, and may be preferably selected from the group consisting of polyethylene glycol, polypropylene glycol, polytetrahydrofuran, polydimethylsiloxane, polyethylene and polypropylene, and more preferably polyethylene glycol.

A molecular weight of the linear molecule according to the present invention may be 500 or more, preferably 1,000 or more, more preferably 2,000 or more.

The capping group in the liquid crystalline polyrotaxane according to the present invention may be selected from the group consisting of dinitrophenyl groups; cyclodextrins; adamantane groups; trityl groups; fluoresceins; pyrenes; substituted benzenes (example of the substituent may include, but are not limited to, alkyl, alkyloxy, hydroxy, halogen, cyano, sulfonyl, carboxyl, amino, phenyl and the like. The substituent may be single or plural.); polycyclic aromatics which may be substituted (examples of the substituent include, but are not limited to, those described above. The substituent may be single or plural.); and steroids. Preferably, the capping group may be selected from the group consisting of dinitrophenyl groups; cyclodextrins; adamantane groups; trityl groups; fluoresceins; and pyrenes, more preferably adamantane groups; or trityl groups.

The cyclic molecule in the liquid crystalline polyrotaxane according to the present invention may be a cyclodextrin molecule which may be substituted. In particular, the cyclic molecule may be a cyclodextrin molecule which may be substituted, and the cyclodextrin may be selected from the group consisting of α-CD, β-CD and γ-CD, and derivatives thereof.

In the liquid crystalline polyrotaxane according to the present invention, the cyclic molecule may be a α-cyclodextrin molecule which may be substituted, and the linear molecule may be polyethylene glycol.

In the liquid crystalline according to the present invention, the linear molecule may have the cyclic molecules included in a skewered manner at an amount of 0.01 to 0.99, preferably 0.1 to 0.9, and more preferably 0.2 to 0.8 of a maximum inclusion amount, which is defined as an amount at which the cyclodextrin molecule can be included at maximum when the linear molecule has the cyclodextrin molecules included in a skewered manner, and the amount at maximum is normalized to be 1.

When the inclusion amount of a cyclic molecule is near the maximum value, there occurs a tendency that the moving distance of a cyclic molecule on a linear molecule is limited. When the moving distance is limited, a tendency of limitation of the degree of expansion and contraction of a material occurs undesirably.

The maximum inclusion amount of a cyclic molecule can be determined depending on the length of the linear molecule and the thickness of the cyclic molecule. For example, when the linear molecule is polyethylene glycol and the cyclic molecule is an α-cyclodextrin molecule, the maximum inclusion amount is measured empirically (see, Macromolecules 1993, 26, 5698-5703, which are entirely incorporated herein).

The liquid crystalline polyrotaxane according to the present invention may be used for at least one selected from the group consisting of materials for display, display elements, recording materials, lithium ion batteries, fuel batteries, solar batteries, actuator, electric double layer capacitors, light-emitting device, electrochromism element, sensors, ionics circuits, polyelectrolyte, electrochemical materials, catalysts, separation membranes, and coating agents.

### <Preparation Method of Liquid Crystalline Polyrotaxane>

The liquid crystalline polyrotaxane can be prepared, for example, as follows:

The liquid crystalline polyrotaxane can be prepared by the method comprising the steps of:

a) mixing a cyclic molecule(s) and a linear molecule to make the linear molecule being included in the cyclic molecule (s) in a skewered manner; and

b) preparing the polyrotaxane by capping each end of the linear molecule with a capping group to prevent the dissociation of the cyclic molecule(s) from the linear molecule; and further comprising:

c) introducing a mesogenic group into the cyclic molecule; in the any timing of the following i) to v);

i) before step (a),

ii) during step (a),

iii) after step (a) and after step (b),

iv) during step (b), or

v) after step (b).

In the preparation method according to the present invention, as for the polyrotaxane, the mesogenic group and the like, those described above can be used.

Steps a) and b) can be conducted according to known methods. For example, the polyrotaxane can be obtained by the method described in U.S. Pat. No. 6,828,378 B2, Japanese Patent Application Laid-Open (JP-A) No. 2005-154675 or the like.

Step (c) will be described hereinafter.

Step (c) is a step of introducing a biphenyl substituent into a cyclic molecule. The step may be conducted in the any timing of (i) to (v), and may be preferably conducted at the timing (v), i.e., after step (b).

In step (c), the step of introducing the mesogenic group can be carried out by using known various methods. For example, conditions employed in the introduction step, which depend on a kind of a mesogenic group to be introduced, the polyrotaxane and the like, has no specific limitation and various reaction methods and conditions can be employed. Specifically, when a bonding group of a mesogenic group (e.g., Y described above) is an ether group (—O—), examples may include those described bellow. Usually, a technique of using halide in the presence of an appropriate base as a catalyst in polar solvent such as dimethylsulfoxide and dimethylformamide is employed. As the base, alkali or alkaline earth metal salts such as sodium methoxide, sodium ethoxide, potassium t-butoxide, sodium hydroxide, potassium hydroxide, caesium hydroxide, lithium hydroxide, potassium carbonate, cesium carbonate, silver oxide, barium hydroxide, barium oxide, sodium hydride and potassium hydride can be used. When the bonding group of the mesogenic group (e.g., Y described above) is a carbonyl group (—CO—), the mesogenic group can be introduced by reacting acid chloride that will become the mesogenic group in the presence of triethylamine.

Especially, in a case of introducing a group represented by the formulae 1 to 3 as the mesogenic group, an acid chloride derivative corresponding to the group may be reacted with the polyrotaxane in the presence of triethylamine.

### EXAMPLES

The present invention will be illustrated by way of the following Examples, but is not limited thereto.

### Example 1

Polyrotaxane used was prepared according to the method described in JP-A No. 2005-154675, and actually purchased from Advanced Softmaterials Inc. and used as it was. In the polyrotaxane, a linear molecule was PEG (weight average molecular weight: 35000), a cyclic molecule was α-cyclodextrin, a capping group was an adamantane group, the number of cyclodextrins included was 90 to 100 per molecule, and an inclusion a mount was 0.25 to 0.3 compared to the maximum inclusion normalized to 1. The other agents were purchased from Wako Pure Chemical Industries, Ltd., Aldrich, Tokyo Chemical Industry Co., Ltd. and the like, and used without purification.

In accordance with P. A. G. Cormack, B. D. Moore, D. C. Sherrington. J. Mater. Chem., 7, 1977-1983 (1997), ethyl 6-(4-cyano-4′-yloxy)hexanoate was prepared from 4-cyano-4′-hydroxybiphenyl (CNBP) and ethyl 6-bromohexanoate, and then hydrolyzed with potassium hydroxide to produce ethyl-6-(4-cyano-4′-yloxy)hexanoic acid (hereinafter, referred to as CNBP—C₅—COOH). Then, CNBP—C₅—COOH (2.48 mmol) was dissolved in 5 ml of thionyl chloride, and stirred for 4 hours at room temperature under argon flow. Then, excess thionyl chloride was distilled away by evaporation to give 6-(4-cyano-4′-yloxy)hexanoyl chloride (hereinafter, referred to as CNBP—C₅—COCl). The all of resultant CNBP—C₅—COCl was used for the following binding reaction without further purification.

To a solution of lithium chloride anhydrous (1.13 g) in dehydrated dimethylacetamide (11.4 g) was added polyrotaxane (126 mg) and dissolved at the temperature from the room temperature to 60° C. Then, the resultant mixture was allowed to cool to room temperature, and added with triethylamine (0.345 ml). To this was added a solution of the CNBP—C₅—COCl obtained above in 3 ml of dehydrate dimethylacetamide dropwise over 20 minutes with ice-cooling, and then stirred for 24 hours under argon flow. After the reaction, the mixture was treated with methanol twice and ion-exchanged water once (200 ml each) to precipitate polyrotaxane CNBP—C₅APR (185 mg) in which a CNBP—C₅-group binds to α-cyclodextrin as a white solid.

### Example 2

In accordance with the method described in, H. Allcock, C. Kin. Macromolecules 23, 3881 (1990) and E. Akiyama, Y. Nagase, N. Koide, K. Araki. Liq. Cryst. 26, 1029 (1999), substance (CNBP-(EO)₂—OH) having a cyanobiphenyl group and a spacer of 2 ethylene glycol repeating units was prepared from 4-cyano-4′-hydroxybiphenyl (CNBP) and ethylene glycol mono-2-chloroethyl ether as raw materials. Subsequently, a solution of CNBP-(EO)₂—OH (4.16 g) in acetone/THF (1:1, 300 ml) was added with 50 ml of saturated aqueous sodium hydrogen carbonate solution, 2,2,6,6-tetramethyl-1-piperidinyloxy radical (TEMPO, 200 mg) and sodium bromide (500 mg), and then slowly added with 68.4 g of 5% hydrogen sodium hypochlorite aqueous solution in an ice bath, and then reacted at room temperature. The reaction was quenched with 2.7 ml of ethanol, and the solvent was distilled away by evaporation to give a substance of which the terminal hydroxyl group was converted to a carboxyl group (hereinafter, referred to as CNBP-(EO)₂—COOH). Then, CNBP-(EO)₂—COOH (2.48 mmol) was reacted with thionyl chloride by a similar procedure as in Example 1 to give a substance (hereinafter, referred to as CNBP-(EO)₂—COCl) of which the terminal carboxyl group was converted to acid chloride. The resultant CNBP-(EO)₂—COCl was linked with polyrotaxane (126 mg) by a similar procedure as in Example 1, or by using a mixed solution of dehydrate dimethylacetamide/lithium chloride anhydrous, and then purified to give polyrotaxane CNBP-(EO)₂APR (115 mg) in which a CNBP-(EO)₂-group binds to α-cyclodextrin as a white solid.

In each ¹H NMR spectrum of those obtained liquid crystalline polyrotaxane derivatives compared with a spectrum of unmodified rotaxane, a peak originated in a hydroxyl group at 4-6 ppm was smaller, and on the other hand, a new peak originated in a phenylbenzoyl or cyanobiphenyl group was appeared at 7-8.2 ppm.

Molecular weights of those polyrotaxane derivatives measured by GPC are shown in Table 1. Both of those large molecular weights showed UV absorption at 245 nm wavelength caused by a benzene ring. Those facts demonstrate that a phenylbenzoyl or cyanobiphenyl group has successfully been introduced into a polyrotaxane.

TABLE 1
Molecular weight of unmodified polyrotaxane
and liquid crystalline polyrotaxane

| | | Weight Average |
|---|---|---|
| | Sample | Molecular Weight |
| | Unmodified Polyrotaxane | 118,000 |
| Example 1 | CNBP-C5-APR | 224,000 |
| Example 2 | CNBP-(EO) 2-APR | 164,000 |

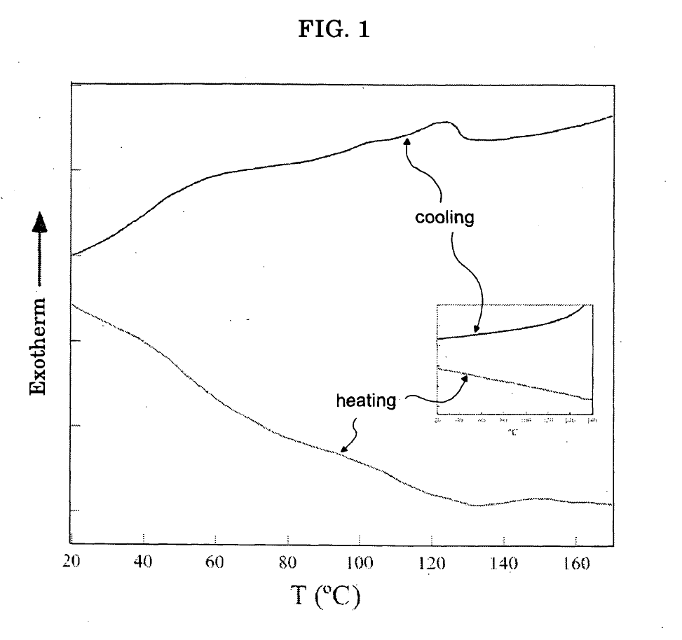

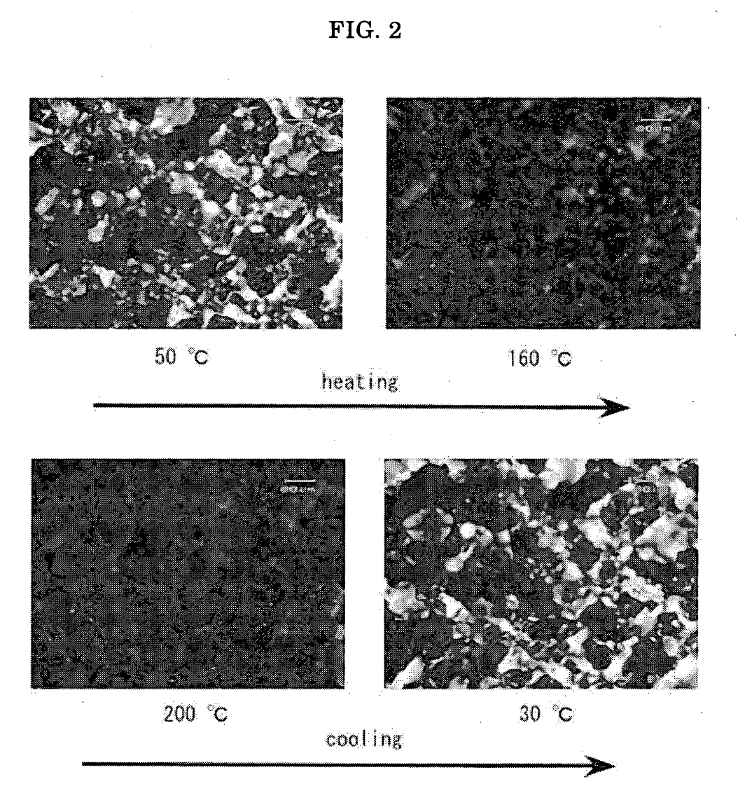

A differential scanning calorimetry curve (hereinafter, simply referred to as “DSC curve”) of CNBP—C₅-APR obtained in Example 1 is shown in FIG. 1. Hereinafter, in performing DSC, rising rate of temperature (in FIG. 1, referred to as “heating”. In FIG. 2 and the rest, same as above) and decreasing rate of temperature (in FIG. 1, referred to as “cooling”. In FIG. 2 and the rest, same as above) were 10° C./minutes. During temperature rising/decreasing, a glass transition temperature-specific baseline shift was observed around 50° C. Additionally, an endothermic and an exothermic broad peaks were also observed at 130° C. in temperature increasing and at 127° C. in temperature decreasing, respectively. It was observed, but not shown, that TG measurement shows weight loss at 150° C. and higher in the atmosphere.

A polarized light microscope image of CNBP—C₅-APR obtained in Example 1 observed under argon flow is shown in FIG. 2. With temperature increasing, CNBP—C₅-APR in the form of white powder was molten at 150° C. After raising to 200° C., with temperature decreasing, CNBP—C₅-APR showed birefringence around 110° C. A microscope image at this time showed a schlieren texture typical of a nematic phase. In the second and later temperature increasing-decreasing scanning, CNBP—C₅-APR repeated disappearance and occurrence of birefringence at 130° C. in temperature increasing and at 110° C. in temperature decreasing, respectively. Since these disappearance and occurrence temperatures of birefringence were near to the endothermic and exothermic temperatures obtained from the DSC above, these temperatures were thought to be transition temperatures of an isotropic phase.

As described above, CNBP—C₅-APR obtained in Example 1 was found to cause glass transition at 50° C., transition from a nematic liquid crystal phase to an isotropic phase at 130° C. and transition from the isotropic phase to the nematic liquid crystal phase at 110° C. in temperature decreasing. That is, CNBP—C₅-APR obtained in Example 1 was found to show liquid crystallinity.

CNBP—C₅-APR obtained in Example 1 was soluble in DMSO, THF and DMAc/LiCl solvent (same solvent as used in preparing CNBP—C₅-APR), but insoluble in the other solvents such as DMF, chloroform, methylene chloride, toluene, methanol, ethanol and acetone.

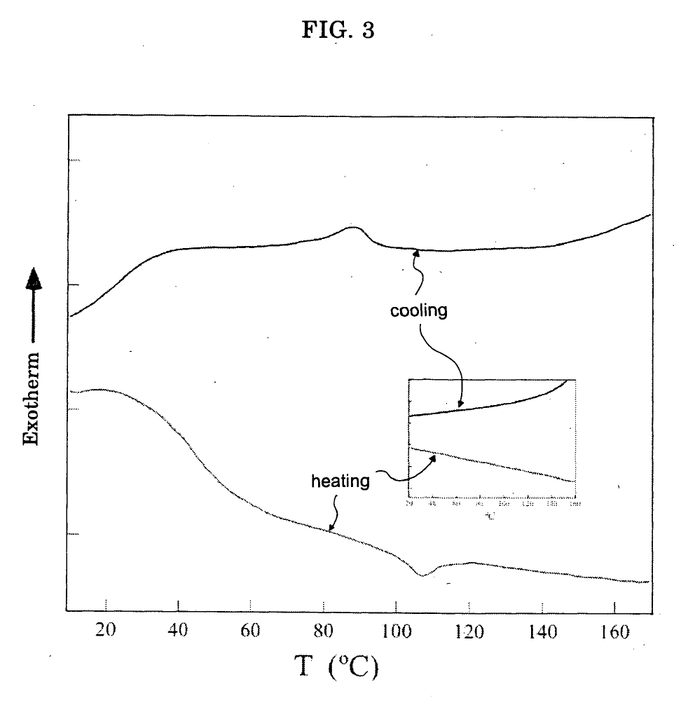

A DSC curve of CNBP-(EO)₂-APR obtained in Example 2 is shown in FIG. 3. During temperature rising/decreasing, a glass transition temperature-specific baseline shift was observed around 55° C. Additionally, an endothermic and an exothermic broad peaks were also observed at 103° C. in temperature increasing and at 94° C. in temperature decreasing, respectively.

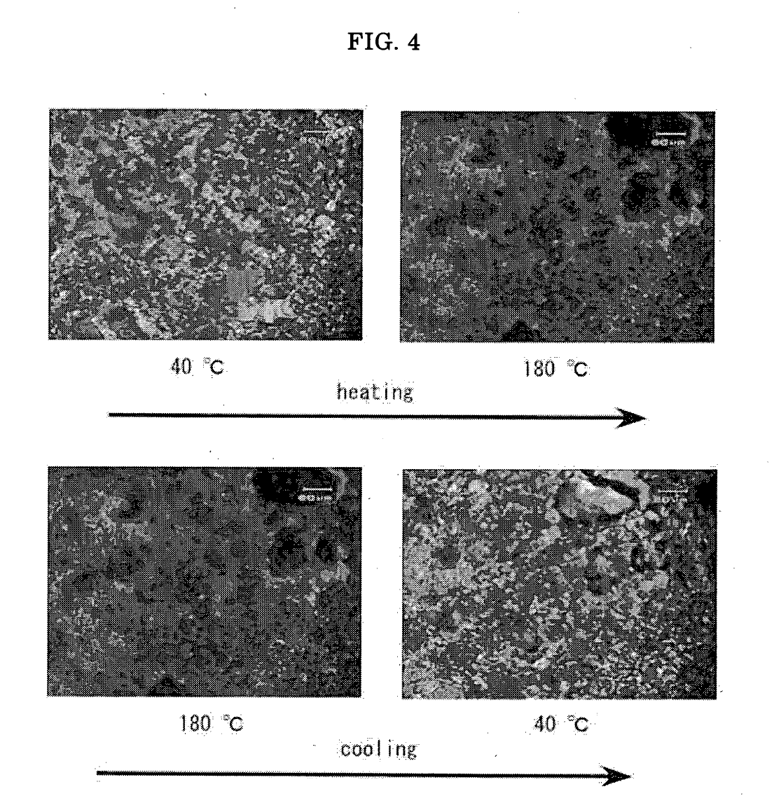

A polarized light microscope image of CNBP-(EO)₂-APR obtained in Example 2 observed under argon flow is shown in FIG. 4. With temperature increasing, CNBP—C₅-APR in the form of white powder was molten at 150° C. After raising to 200° C., with temperature decreasing, CNBP-(EO)₂-APR showed birefringence around 100° C. A microscope image at this time showed a schlieren texture typical of a nematic phase. In the second and later temperature increasing-decreasing scanning, CNBP-(EO)₂-APR repeated disappearance and occurrence of birefringence at 110° C. in temperature increasing and at 100° C. in temperature decreasing, respectively. Since these disappearance and occurrence temperatures of birefringence were near to the endothermic and exothermic temperatures obtained from the DSC above, these temperatures were thought to be transition temperatures of an isotropic phase.

As described above, CNBP-(EO)₂-APR obtained in Example 2 was found to cause glass transition to a mesophase at 35° C., transition from a nematic liquid crystal phase to an isotropic phase at 100° C. and transition from the isotropic phase to the nematic liquid crystal phase at 110° C. in temperature decreasing. However, birefringence could occur at 130° C., in an observation of sample with searing in cooling. The reason is thought that polyrotaxane in molten state was orientated by being sheared and thereby birefringence was more easily induced. That is, CNBP-(EO)₂-APR obtained in Example 2 was found to show liquid crystallinity.

What is claimed that:

1. A liquid crystalline polyrotaxane consisting essentially of a polyrotaxane,
wherein the polyrotaxane comprises a linear molecule, a cyclic molecule(s) in which the linear molecule is included in cavity (cavities) of the cyclic molecule(s) in a skewered manner, and capping groups, each of which locates at each end of the linear molecule in order to prevent the dissociation of the cyclic molecule(s)
the cyclic molecule of the liquid crystalline polyrotaxane comprises a mesogenic group, and
the liquid crystalline polyrotaxane has liquid crystalline property.

2. The liquid crystalline polyrotaxane according to claim 1, wherein the mesogenic group is represented by the formula A-X—B—C—Y— wherein A and B are 6-membered rings; C is a single bond or a liner chain group; and X and Y are bonding groups.

3. The liquid crystalline polyrotaxane according to claim 2, wherein the 6-membered rings of A and B each independently represents a saturated or unsaturated homo- or heterocycle, which may be substituted.

4. The liquid crystalline polyrotaxane according to claim 2, wherein C has a linear chain consisting of 0 to 100 elements.

5. The liquid crystalline polyrotaxane according to claim 3, wherein C has a linear chain consisting of 0 to 100 elements.

6. The liquid crystalline polyrotaxane according to claim 2, wherein X is selected from the group consisting of a single bond, —CO—O—, —O—CO—, —N═N—, an azoxy group, —N═CH—, —CH═N—, —CH═CH— and —C≡C—.

7. The liquid crystalline polyrotaxane according to claim 2, wherein Y is selected from the group consisting of a single bond, —O—, —CO—, —CO—O—, —O—CO—, —NH—CO—, —CO—NH—, —NH—CO—O— and —O—CO—NH—.

8. The liquid crystalline polyrotaxane according to claim 2, wherein A-X—B— is selected from the group consisting of D-1 to D-20 wherein R¹ to R²⁰ each independently represents a substituent:

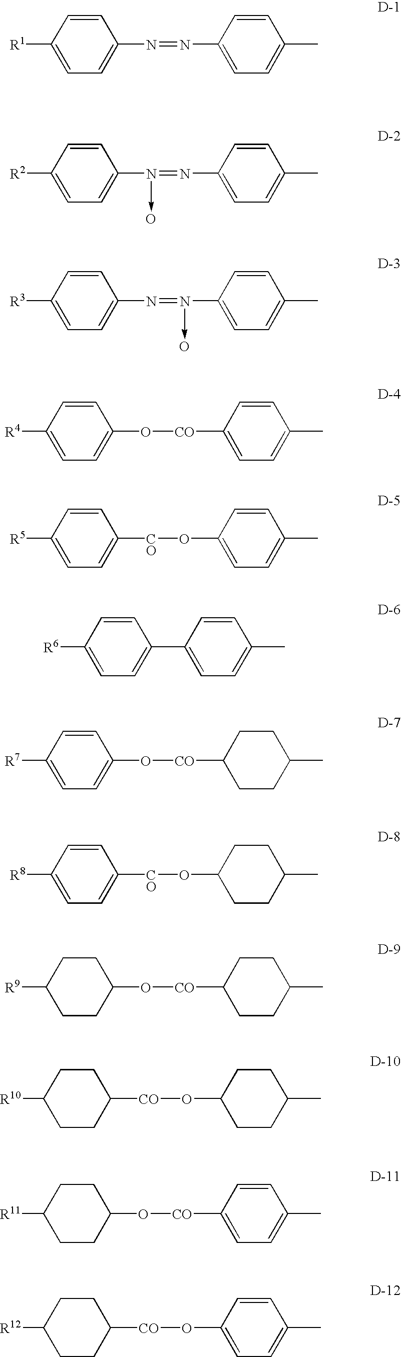

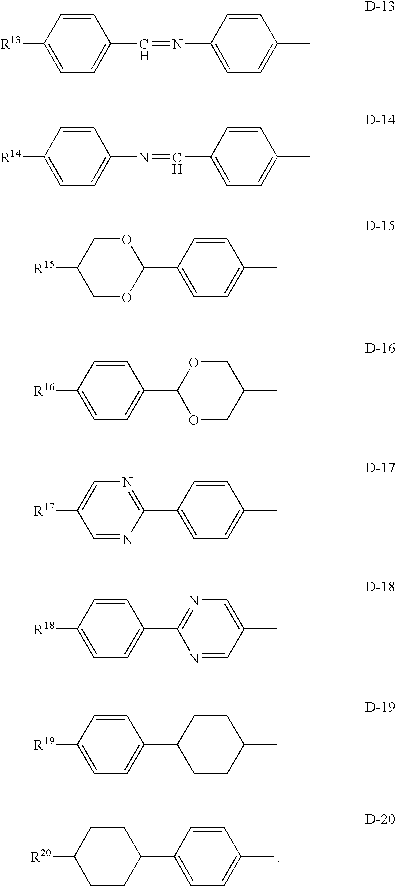

9. The liquid crystalline polyrotaxane according to claim 1, wherein the mesogenic group represents any one of biphenyl substituents represented by following formulae 1 to 3, wherein n is an integer of 1 to 20; m is an integer of 1 to 10; R²¹, R²³ and R²⁵ each independently represents 0 to 5 substituents; and R²², R²⁴ and R²⁶ each independently represents 0 to 4 substituents:

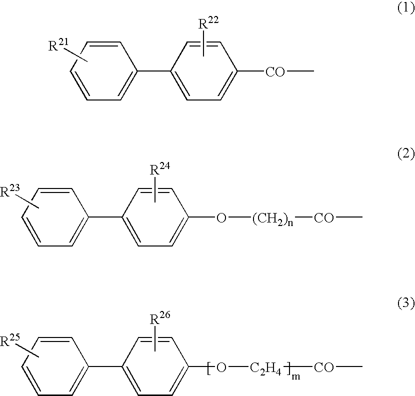

10. The liquid crystalline polyrotaxane according to claim 9, wherein the biphenyl substituent is represented by the formula 1, wherein R²¹ has one substituent which is a cyano group in p-position, and R²² has no substituent.

11. The liquid crystalline polyrotaxane according to claim 9, wherein the biphenyl substituent is represented by the formula 2, wherein n is an integer of 2 to 10, R²³ has one substituent which is a cyano group in p-position, and R²⁴ has no substituent.

12. The liquid crystalline polyrotaxane according to claim 9, wherein the biphenyl substituent is represented by the formula 3, wherein m is an integer of 1 to 5, R²⁵ has one substituent which is a cyano group in p-position, and R²⁶ has no substituent.

13. The liquid crystalline polyrotaxane according to claim 1, wherein the linear molecule is selected from the group consisting of polyvinyl alcohol, polyvinylpyrrolidone, poly(meth) acrylic acid, cellulose-based resins, polyacrylamide, polyethylene oxide, polyethylene glycol, polypropylene glycol, polyvinyl acetal-based resins, polyvinyl methyl ether, polyamine, polyethyleneimine, casein, gelatin, starch and the like and/or copolymers thereof, polyolefin-based resins such as polyethylene, polypropylene, and copolymer resins with other olefinic monomers, polyester resins, polyvinyl chloride resins, polystyrene-based resins, acrylic resins, polycarbonate resins, polyurethane resins, vinyl chloride-vinyl acetate copolymer resin, polyvinylbutyral resin and the like; and derivatives and modifications thereof, polyisobutylene, polytetrahydrofuran, polyaniline, acrylonitrile-butadiene-styrene copolymer (ABS resin), polyamides such as nylon and the like, polyimides, polydienes such as polyisoprene, polybutadiene and the like, polysiloxanes such as polydimethylsiloxane and the like, polysulfones, polyimines, polyacetic anhydrides, polyureas, polysulfides, polyphosphazenes, polyketones, polyphenylenes, polyhaloolefins, and derivatives thereof.

14. The liquid crystalline polyrotaxane according to claim 1, wherein the linear molecule has a molecular weight of 500 or more.

15. The liquid crystalline polyrotaxane according to claim 1, wherein the capping group is selected from the group consisting of dinitrophenyl groups; cyclodextrins; adamantane groups; trityl groups; fluoresceins; pyrenes; substituted benzenes; polycyclic aromatics which may be substituted; and steroids.

16. The liquid crystalline polyrotaxane according to claim 1, wherein the cyclic molecule is a cyclodextrin molecule which may be substituted.

17. The liquid crystalline polyrotaxane according to claim 1, wherein the cyclic molecule is a cyclodextrin molecule which may be substituted, and the cyclodextrin molecule is selected from the group consisting of α-cyclodextrin, β-cyclodextrin and γ-cyclodextrin, and derivatives thereof.

18. The liquid crystalline polyrotaxane according to claim 1, wherein the cyclic molecule is α-cyclodextrin which may be substituted, and the linear molecule is polyethylene glycol.

19. The liquid crystalline polyrotaxane according to claim 1, wherein the linear molecule may have the cyclic molecule included in a skewered manner at an amount of 0.01 to 0.99 of a maximum inclusion amount, which is defined as an amount at which the cyclodextrin molecule can be included at maximum when the linear molecule has the cyclic molecules included in a skewered manner, and the amount at maximum is normalized to be 1.

20. The liquid crystalline polyrotaxane according to claim 1, which is used for at least one selected from the group consisting of materials for display, display elements, recording materials, lithium ion cells, fuel cells, solar cells, actuator, electric double layer capacitors, light-emitting devices, electrochromism elements, sensors, ionics circuits, polyelectrolyte, electrochemical materials, catalysts, separation membranes, and coating agents.

21. A method for preparing a liquid crystalline polyrotaxane consisting essentially of polyrotaxanes and exhibiting liquid crystallinity, comprising the steps of:
a) mixing a cyclic molecule(s) and a linear molecule to make the linear molecule being included in the cyclic molecule (s) in a skewered manner; and
b) capping each end of the linear molecule with a capping group to prevent the dissociation of the cyclic molecule(s) from the linear molecule, to prepare the polyrotaxane;
and further comprising:
c) introducing a mesogenic group into the cyclic molecule;
in the any timing of the following i) to v);
i) before step a),
ii) during step a),
iii) after step a) and before step b),
iv) during step b), or
v) after step b).

22. The method according to claim 21, wherein step (c) is conducted at the timing (v) after step b).
